(19) United States
(12) Patent Application Publication
(10) Pub. No.: US 2002/0125061 A1
(43) Pub. Date: Sep. 12, 2002

(54) Steering wheel electrical power transmission and signal exchange device

(75) Inventor: Koushi Kawamura, Yokkaichi-city (JP)

Correspondence Address: GREENBLUM & BERNSTEIN, P.L.C., 1941 ROLAND CLARKE PLACE, RESTON, VA, 20191, US

(73) Assignee: Sumitomo Wiring systems, Ltd., Yokkaichi-city (JP)

(21) Appl. No.: 10/078,412

(22) Filed: Feb. 21, 2002

(30) Foreign Application Priority Data
Mar. 8, 2001 (JP) 2001-064951

(51) Int. Cl. B62D 9/00

(52) U.S. Cl. 180/400; 280/775

(57) ABSTRACT

An electrical power transmission and signal exchange device is configured to maintain a high rate of electrical power transmission speed between an automotive vehicle body and steering wheel. The device primarily includes a rotating transmission that includes a rotating part and fixed part mutually assembled to define an internal space. Multiple electrical circuits are provided in the form of electrical power coils are connected to an airbag igniter without the inclusion of a multiplexing circuit, and signal exchange coils are connected to printed circuit boards that include multiplexing circuits.

### BACKGROUND OF THE INVENTION

1. Field of the Invention

The invention relates to an electrical power transmission and signal exchange device incorporated into a steering wheel assembly, and in particular, to a device that maintains the required electrical power transmission speed while providing for the installation of an increased number of electrical signaling circuits between the vehicle body and the steering wheel.

2. Discussion of Background Information

Automotive steering wheels generally incorporate airbags to protect drivers in the event of a collision. Many steering wheels also incorporate numerous electrical switches such as horn, transmission, cruise, and radio control switches to operate the corresponding devices installed to the vehicle body. Electrical power supplied from the vehicle body is used to deploy the airbag, and various electrical signals are sent between the steering wheel and vehicle body for application to various switches and other electrical devices. A steering wheel cable reel is normally used as means of transmitting this electrical power and conducting these switching signals.

FIGS. 10(A) and 10(B) illustrate a conventional cable reel 1 into which rotor 1b is installed in a non-constrained rotatable condition, rotor 1b being attached to boss 2a of steering wheel 2 and rotatably mounted to cylindrical case 1a which is, in turn, fixedly installed to the steering column (not shown in the drawing). Flat cable 3, formed of multiple electrically conductive wires, is housed within case 1a in a spiral configuration and incorporates connector terminals C1 and C2 at both ends respectively.

Vehicle-side terminal C1 is connected to wiring harness W/H that forms part of the power and switching signal circuits located in the vehicle. Steering wheel-side connector C2 is connected to the electrical power and signal circuits in steering wheel 2. Through this structure, flat cable 3 is able to provide electrical conductivity between the electrical circuits in the vehicle body and steering wheel, the number of conductive wires in flat cable 3 corresponding to the number of circuits used to transfer power and exchange signals between the steering wheel and vehicle body. Moreover, in regard to the method of winding the flat cable, in addition to the spiral orientation of the flat cable shown in FIG. 10B , FIG. 11 illustrates a folded over cable arrangement in which ring 4′ is used to position folded over flat cable 3′.

Furthermore, in addition to using a cable reel as means of transmitting electrical power and exchanging signals as explained above, FIGS. 12A and 12B illustrate a structure described by Japanese Laid Open Patent 58-115945 in which a rotating transformer 5 is incorporated into the steering wheel. Rotating transformer 5 includes magnetic cores 8A and 9A respectively installed to steering wheel 6 and fixed part 7 on the vehicle body side, and coils 8B and 9B respectively installed to magnetic cores 8A and 9A. A clearance is maintained between opposing coils 8B and 9B that are connected to a signal transmission multiplexing device (not shown in the drawing) on the vehicle body side and steering wheel side. Rotating transformer 5 generates electromagnetic inductance between coil 9A and 9B, and is thus able to transmit both electrical power and electrical signals between the vehicle body and steering wheel.

There has been a recent tendency to increase the number of switches and other electrical controls installed to the steering wheel in an effort to make it easier for the driver to operate the various electrical devices incorporated into the vehicle. This tendency has resulted in a corresponding increase in the number of circuits running between the vehicle body and steering wheel. The size of the case used to house the current cable reel mechanism is limited by the available space around the steering wheel. Furthermore, the width of the flat cable is also limited, and thus is only able to include from 12 to 18 wires, thereby restricting the number of circuits to which the flat cable can be applied.

Moreover, because the cable reel design uses a flat cable whose spiral winding moves in unison with the rotations of the steering wheel, or a rotor that includes multiple rotating parts, vibrations generated by the turning steering wheel and ride motions of the vehicle can cause these mechanisms to generate unwanted noise, thus lowering the sales appeal and marketability of the vehicle. Moreover, in regard to the cable reel assembly process, the cable reel must be installed within its case in an orientation that allows the flat cable to follow the bi-directional rotations of the steering wheel, and the flat cable must also be provided with a length that allows its rotational extension and retraction to correspond to the movement of the steering wheel. These factors make assembly of the cable reel relatively difficult and time consuming.

Designs of the type utilizing rotating transformer 5 allow for the utilization of many circuits provided that there is space to locate the opposing coils required with this design. This design, however, still poses a problem in that electrical transmission speed is reduced as a result of the electrical power and signals traveling from one coil to the other through an electromagnetic induction process that requires a multiplexing device to perform separation and restoration operations. This reduction in transmission speed renders the system unusable for airbag equipped steering wheels in which immediate deployment of the airbag is required.

That is to say, as the airbag must be deployed instantaneously after a collision is detected, electrical power must be supplied to the airbag igniter as quickly as possible. The use of rotating transformer 5, however, results in the multiplexing device creating a power transmission bottleneck that reduces the speed at which electrical power can be supplied, thus making the system that uses transformer 5 inapplicable to modern automobiles equipped with airbags as standard equipment.

### SUMMARY OF THE INVENTION

Taking into consideration the problems described above, the present invention provides a device for transferring electrical power to an airbag or other device at a high rate of speed, and for accommodating the installation of an increased number of electrical signaling circuits between the vehicle body and steering wheel.

In order to provide an effective solution to the previously described problems, the present invention proposes a steering wheel electrical power transmission and signal exchange device including a rotating part installed on the steering wheel side, the rotating part revolving in unison with the steering wheel, a fixed part installed to the vehicle body side and mutually assembled with the rotating part so as to form an internal space, and a rotating transformer located within the internal space transmits electrical power and signals between circuits in the vehicle body and steering wheel. The rotating transformer includes at least two pair of mutually opposed coils, one coil of each pair being located in the rotating part and fixed part, and each coil pair being independently applied for electrical power or electrical signal exchange purposes. The pair of coils used for electrical power transmission is connected to an electrical current converter and forms an electrically conductive connection between electrical power circuits in the vehicle body and steering wheel, and the pair of coils used for electrical signal exchange is connected to signal multiplexing and restoration device, and forms an electrically conductive connection between electrical signal circuits in the vehicle body and steering wheel.

This type of rotating transformer, which includes multiple coil pairs independently applied to electrical power transmission and signal exchange purposes, is able to satisfy the transmission requirements for various types of electrical devices. In other words, because multiplexing and restoration processes must be respectively executed before and after transmission and reception, the signal exchange coils make it possible to transmit and receive electrical signals for each device through one pair of coils connected to a multiplex processing and restoration device. Furthermore, because electrical power does not exist in various forms as do electrical signals, there is no need to apply means to differentiate the electrical power to be supplied to each device. As a result, the pair of coils used for electrical power transmission does not incorporate a multiplex processing and restoration device, but uses an inverter or other like electrical current conversion device that is able to convert alternating current into direct current at the time of electromagnetic induction; and by connecting the coils to the airbag igniter in the steering wheel, it becomes possible to inflate the airbag at an appropriate response speed through fast and timely transmission of electrical power.

Moreover, as the aforesaid electrical current converter is applied only to convert alternating and direct current, there is no falloff in power transmission speed because there is no processing time required. Furthermore, in regard to the use of an electrical current converter, even though the electromagnetic induction of the rotating transformer operates on the basis of alternating current, the direct current battery installed in the vehicle is still able to activate the airbag igniter through the application of direct current.

Moreover, the rotating transformer is able to accommodate an increase in the number of electrical signal circuits, multiplex and transmit multiple signals from one coil to the other through electromagnetic induction, and apply a multiplex signal restoration device to reliably restore the multiplexed signals to their original state. Furthermore, should the number of signals to be processed exceed the capacity of the multiplex processing and restoration device, an additional pair of coils can be added to accommodate the increased number of signals.

In addition, because the rotating transformer eliminates the use of a conventional flat cable, not only is a source of undesirable noise eliminated, the rotational movement of the revolving parts becomes smoother due to the complete absence of the flat cable. Furthermore, assembly time and cost can be significantly reduced because the need to adjust the rotational extension and retraction length of the flat cable during installation is eliminated. Moreover, the coils are installed to magnetic cores attached to the rotating and fixed parts, and if these coils are made from a mixture of plastic resin and ferrite materials, a structure is created whereby weight is reduced and the generation of noise suppressed.

It is desirable to structure the aforesaid multiplex processing and restoration device to include integrated circuits contained within printed circuit boards installed to the rotating and fixed parts. The use of this type of integrated structure, a structure that incorporates electrical circuits for multiplex processing of multiple signals as well as circuits for the restoration device, not only improves circuit reliability but also realizes a more compact structure that requires less space. It is further desirable that the integrated circuits be contained within printed circuit boards that may be easily installed to the rotating and fixed parts.

The fixed part is formed as a generally cylindrical structure having a closed end attached to the vehicle body side and an open end located opposite to the closed end. The rotating part incorporates a generally circular cover plate that covers the open end of the fixed part. One coil of the pair of coils is installed to the surface of the cover plate facing the internal space, and the other coil is attached to the inward facing surface of the closed end of the fixed part, thus forming a structure that maintains the respective coils at upper and lower positions in concentric axial alignment.

The fixed and rotating parts of the present invention form a structure that can replace the conventional cable reel, a structure that can be installed to the steering wheel in the conventional manner and housed in the steering column to follow the rotational movement of the steering wheel. Furthermore, the orientation of the coils in concentric axial alignment simplifies the assembly process for the fixed and rotating parts, and allows the height of the fixed part to be reduced. Moreover, while increasing the number of coil pairs would increase the diameter of the device, the height dimension of the device would be unchanged, thus providing a specific advantage in situations where space between the steering column and steering wheel is limited.

Moreover, with the fixed part formed to have a generally cylindrical shape, a cylindrical structure is provided at the center of the rotating part cover plate that covers the open end of the fixed part, the cylindrical structure extending from the inward facing surface of the cover plate into the internal space defined by the fixed part. One coil of the pair of coils is fixedly attached to the rotating part at the external radial wall of the cylindrical structure, and the other coil at the inward facing radial surface of the perimeter wall of the fixed part, thus orienting the respective coils in mutually concentric inner and outer positions on the radial plane.

Locating the respective coils of the pair in concentric inner and outer positions on the same radial plane, as described above, simplifies the process through which the rotating and fixed parts are assembled and allows the device to be made to compact dimensions on the radial axis. Furthermore, if additional pairs of coils are installed, the height of the device will increase but the diameter will remain unchanged, thus making the device highly advantageous for applications where there is little space around the steering column.

In another aspect of the present invention, a steering wheel electrical power transmission and signal exchange device is provided that includes a rotating part fixedly attached to a steering wheel so as to rotate in unison with the steering wheel, a fixed part fixedly attached to the vehicle body and located adjacent to the rotating part, and an electric power transmission and electrical signal exchange device operatively connected between the rotating part and the fixed part and configured to transfer electrical power at a high rate of speed to an airbag mounted to the steering wheel and to accommodate an increased number of electrical signaling circuits between the vehicle body and the steering wheel.

The electric power transmission and electrical signal exchange device of the steering wheel electrical power transmission and signal exchange device may include a rotating transformer positioned between the rotating part and the fixed part to exchange electrical power transmission and signals between the vehicle body and steering wheel, wherein the rotating transformer includes at least two pair of mutually opposing coils, the individual coils of each coil pair being installed to the rotating part and fixed part, respectively, one coil pair being designated for electrical power transmission and one coil pair being designated for electrical signal exchange, and wherein each coil of the coil pair designated for electrical power transmission is electrically connected to electrical current converter and electrical power circuits located on the vehicle body side and steering wheel side respectively, and each coil of the coil pair designated for electrical signal exchange is electrically connected to a multiplex processing and restoration device located on the vehicle body side and steering wheel side, respectively. Additionally, the multiplex processing and restoration devices may be installed to the rotating and fixed part, respectively, in the form of integrated circuits contained in printed circuit boards.

In a further aspect of the steering wheel electrical power transmission and signal exchange device of the present invention, the fixed part may have a generally cylindrical shape closed at the vehicle body side extremity and open at the other extremity, the rotating part may include a generally circular cover plate positioned to cover the open extremity of the fixed part, and one coil of a pair of coils may be attached to the surface of the cover plate facing an internal space, and the other coil of the pair of coils may be attached to the surface of the fixed part facing the same internal space, the disposition of the coils thus forming a pair of concentric coils mutually opposed at upper and lower positions in the axial direction.

In still another aspect of the steering wheel electrical power transmission and signal exchange device of the present invention, the fixed part may have a generally cylindrical shape, the rotating part may incorporate a generally cylindrical structure that protrudes from a central region of a generally circular cover plate, the cover plate being disposed so as to close an open end of the fixed part, into an internal space of the fixed part, and one coil of the coil pair may be attached to the externally facing radial surface of the cylindrical structure of the rotating part, and the other coil to the internally facing radial surface of the fixed part, the coil pair being thus disposed as inner and outer concentric coils on the same radial plane.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of the electrical power transmission and signal exchange device invention, as described in a first embodiment, illustrating how the present invention installs to the vehicle;

FIG. 2 is an exploded perspective view of the invention described by the first embodiment;

FIG. 3 is a perspective view of the magnetic core part;

FIG. 4 is a perspective view of the invention;

FIG. 5 is an electrical schematic illustrating the circuits running between the vehicle body and steering wheel;

FIG. 6 is a cross sectional view of a variation of the first embodiment of the present invention;

FIG. 7 is a cross sectional view of a second embodiment of the present invention;

FIGS. 8(A) and 8(B) are oblique views of the inner and outer magnetic cores respectively;

FIG. 9 is a cross sectional view of a modified version of the second embodiment of the present invention;

FIGS. 10(A) and 10(B) are respective perspective and exploded perspective views of a conventional cable reel mechanism;

FIG. 11 is an exploded perspective view of a modified version of the conventional cable reel mechanism shown in FIG. 10;

FIG. 12(A) is a cross sectional view of a conventional rotating transformer type electrical power transmission and signal exchange device; and

FIG. 12(B) is a perspective view, partially in cross section, of the device shown in FIG. 12(A).

### DETAILED DESCRIPTION OF THE PRESENT INVENTION

The following will provide a description of an embodiment of the present invention with reference to the drawings.

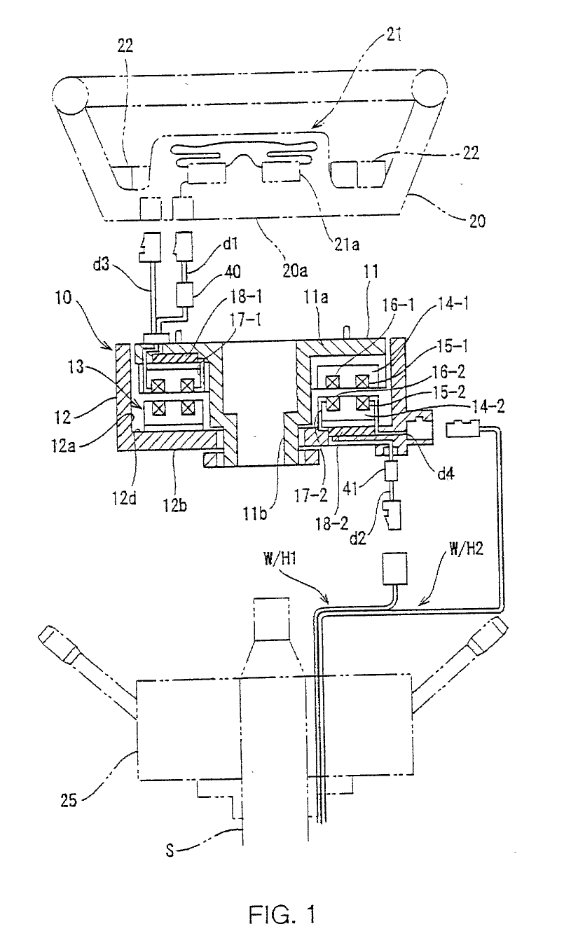

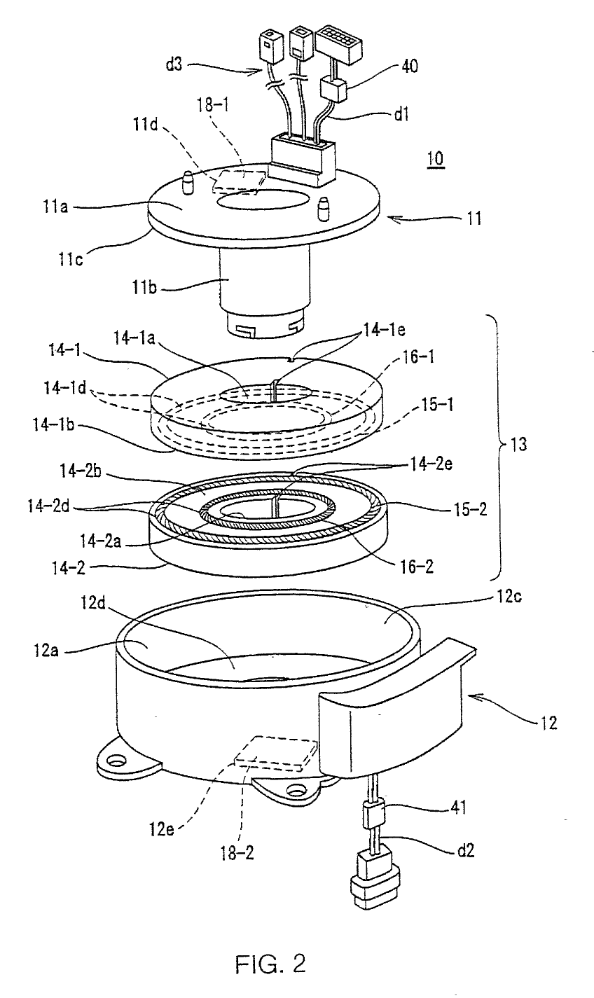

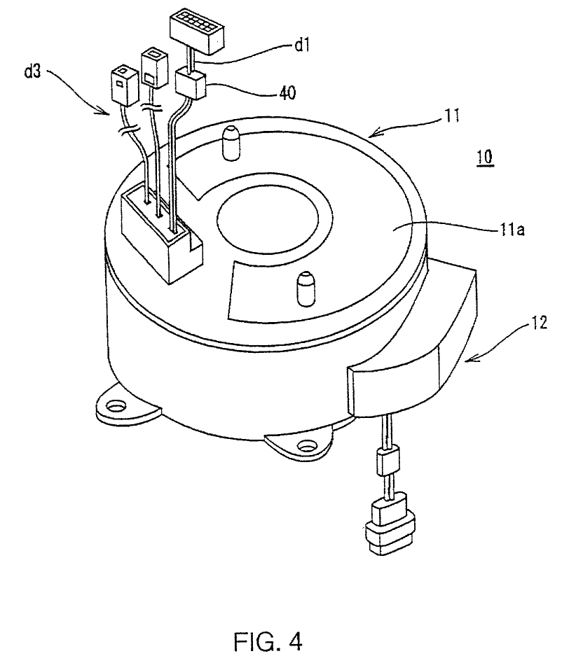

FIGS. 1, 2, and 4 describe a first embodiment of the invention shown as steering wheel electrical power transmission and signal exchange device 10 in which rotating part 11 is installed to the steering wheel and fixed part 12 to the vehicle body. Rotating transformer 13, including electrical power and signal exchange coils 15-1, 15-2, 16-1, and 16-2, is located within internal space 12a.

Rotating part 11 is primarily formed of donut shaped closure plate 1 la and a cylindrical part 11b extending downwardly from plate 11a. Fixed part 12 is attached to the vehicle body, is approximately cylindrical in shape, and includes enclosure face 12b that closes the lower end of the cylindrical space, and opening 12c into which rotating part 11 is installed in a rotatable condition. Moreover, printed circuit boards 18-1 and 18-2 (to be subsequently discussed) are respectively installed within recesses 11d and 12e provided on rotating part 11 at lower surface 11c of closure plate 11a, and fixed part 12 at inner end surface 12d of enclosing surface 12b.

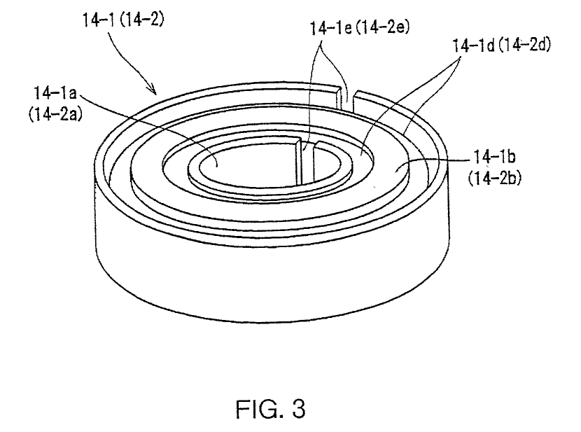

As shown in FIG. 3, magnetic cores 14-1 and 14-2 of rotating transformer 13 are respectively installed to rotating part 11 at internally facing lower face 11c of closure plate 11a, and to fixed part 12 at inner end face 12d of enclosure face 12b. Magnetic cores 14-1 and 14-2 are generally round, uniformly thick plate-type members incorporating orifices 14-1a and 14-2a that allow the insertion of steering column “S” and cylinder structure 11b of rotating part 11. Annular channels 14-1d and 14-2d, formed at two locations as separated concentric grooves into which the coils are installed, are formed in mutually opposing surfaces 14-1b and 14-2b respectively. Furthermore, electrical wire passage slots 14-1e and 14-2e are formed into the outer and inner circumferential walls of magnetic cores 14-1 and 14-2 in order to accommodate the passage of electrical wires to ring channels 14-1d and 14-2d. Moreover, in the first embodiment, the magnetic cores 14-1 and 14-2 are preferably formed by injection molding from a ferrite-resin material. However, the magnetic cores may be formed in any suitable manner from any suitable material.

Annular channels 14-1d and 14-2d of magnetic cores 14-1 and 14-2 enable two pairs of coils to be installed within rotating transformer 13, one of the pair including coils 15-1 and 15-2, and the other pair including coil 16-1 and 16-2.

To be more specific, coils 15-1 and 15-2 are installed into outer annular channels 14-1d and 14-2d respectively and are used for electric power transmission. Coil 15-1 is installed within rotating part 11 and is directly connected to igniter 21a through hookup wire d1 running through wire passage slot 14-1e, igniter 21a being used to deploy airbag 21 located in steering wheel 20. In addition, hookup wire d1 connects to coil 15-1 through DC/AC inverter 40 that serves as an electrical current conversion device. Moreover, coil 15-2 is installed to fixed part 12 and is directly connected to the electric power supply circuit in the vehicle body by hookup wire d2 that runs through wire passage slot 14-2e and directly connects to wiring harness W/H1. Hookup wire d2 is connected to coil 15-2 through AC/DC inverter 41 that serves as the electrical power conversion device.

Electrical signal exchange coils 16-1 and 16-2 are installed within inner annular channels 14-1d and 14-2d respectively, and are connected to multiplex signal processing and restoration printed circuit boards 18-1 and 18-2 respectively through hookup wires 17-1 and 17-2 that pass through slots 14-1e and 14-2e.

Printed circuit boards 18-1 and 18-2 are of unitized structure that integrates the respective multiplex processing and restoration circuits. The multiplex processing circuits of printed circuit boards 18-1 and 18-2 are able to separate multiple transmitted electrical signals through frequency division electromagnetic induction, and to classify a variety of different frequencies in AM, FM, and other frequency bands into separate signals, thereby accommodating a significantly larger number of circuits than is possible with conventional cable reels that are limited to, for example, 18 circuits.

Printed circuit boards 18-1 and 18-2 are installed in recesses 11d and 12e of rotating part 11 and fixed part 12 respectively prior to the installation of magnetic cores 14-2 and 14-2. Hookup wire d3 extends from printed circuit board 18-1 of rotating part 11 to establish a connection with multiple switches 22 in steering wheel 20. Hookup wire d4 extends from printed circuit board 18-2 of fixed part 12 to establish a connection with wiring harness W/H2 that forms the signal exchange circuits located throughout the vehicle body. Moreover, while the above describes printed circuit boards 18-1 and 18-2 as being located within recesses 11d and 12e, they may also be installed at a location external to rotating part 11 and fixed part 12.

Thus, the electrical power transmission and signal exchange device 10 is able to support coil pairs 15-1/15-2 and 16-1/16-2 of internal transformer 13 in concentrically opposed alignment in the axial direction while maintaining the desired clearance between the coils of each opposing pair, and to maintain the dimensional relationship between the pairs of coils when rotating part 11 rotates in unison with steering wheel 20. Furthermore, operational noise is reduced and the manufacturing assembly process made more efficient due to the elimination of the spiral wound flat cable conventionally installed within space 12a of electrical power transmission and signal exchange device 10. In addition, because the external configuration of the electrical power transmission and signal exchange device 10 is approximately the same as a conventional cable reel, no modifications are required on the vehicle body to install device 10, thus allowing device 10 to be installed in the same manner as a cable reel assembly.

In regard to installing the electrical power transmission and signal exchange device 10 to the vehicle body, as shown in FIG. 1, fixed part 12 is fixedly attached to steering column 25, and rotating part 11 is installed to steering wheel 20 through boss 20a. In regard to electrical connections, the appropriate circuits are completed through hookup wire d1 connecting to airbag igniter 21a, hookup wire d2 to wiring harness W/H1, hookup wire d3 to the switching circuits in steering wheel 20, and hookup wire d4 to wiring harness W/H2.

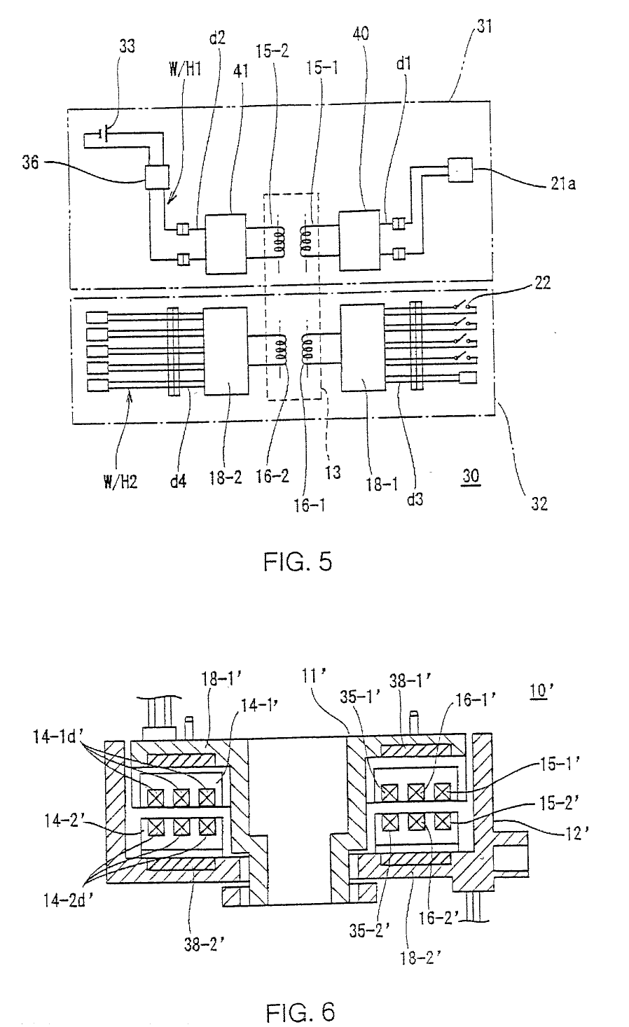

FIG. 5 illustrates a circuit 30 located between the above described vehicle body and steering wheel. The upper circuit is a power transmission circuit 31 (outlined by a double chain line), and the lower circuit is a signal exchange circuit 32 (outlined by a single chain line). Direct current from battery 33, the electrical power source in the vehicle body, is applied to power transmission circuit 31 through controller 36 and wiring harness W/H1, to AC/DC inverter 41 through hookup wire d2, and converted to alternating current by inverter 41. Applying an electromagnetic induction process, rotating transformer 13 supplies the electrical current from coil 15-2 on the vehicle body side to coil 15-2 on the steering wheel side.

Current runs through hookup wire d1 to DC/AC inverter 40 where it is converted back to direct current and applied to airbag igniter 21a in steering wheel 20. In this manner, power transmission circuit 31 is able to maintain a high current transmission rate without a falloff in transmission speed that normally results from current being processed through a multiplexing circuit, and is thus able to respond to the requirement for extremely fast application of electrical power to airbag igniter 21a.

Electrical signals sent to signal exchange circuit 32 by various switches 22 in steering wheel 20 are subjected to multiplex processing by printed circuit board 18-1 located in rotating part 11, transmitted from coil 16-1 of rotating transformer 13 on the steering wheel side to coil 16-2 on the vehicle body side, restored to their original state by printed circuit board 18-2 located in fixed part 11, and applied to the corresponding devices throughout the vehicle body through wiring harness W/H2. As signal exchange circuit 32 is designed to handle approximately 30 separate switching circuits, it adequately accommodates an increase in the number of electrical switches installed to steering wheel 20. Furthermore, for vehicles that have only an airbag in the steering wheel, the rotating transmission may be structured so as to include only electrical power circuit 32, and to eliminate signal exchange circuit 32.

FIG. 6 describes a variation of the first embodiment wherein electrical power transmission and signal exchange device 10′ incorporates a rotating transformer configured from magnetic cores 14-1′ and 14-2′ that include three annular channels 14-1d′ and 14-2d′ into which coils 15-1′, 15-2′, 16-1′, 16-2′, 35-1′, and 35-2′ are installed. Coil pairs 15-1′/15-2′ and 16-1′/16-2′ are, as described in the previous embodiment, utilized for electrical power and signal exchange respectively. Additional coil pair 35-1′/35-2′ is utilized for signal exchange, the coils are configured in the same manner as coils 16-2′ and 16-2′, and are connected to printed circuit boards 38-1′ and 38-2′ that include multiplex processing and restoration circuits respectively.

The incorporation of additional coil pair 35-1′/35-2′ allows an even greater number of switching circuits to be utilized, and the number of circuits can be up to three times larger than possible with a conventional cable reel design. While electrical power transmission and signal exchange device 10′ includes a greater number of coils compared to that installed to device 10 of the previous embodiment, the height dimension of the device remains unchanged, and the diameter is only slightly larger. The first embodiment of electrical power transmission and signal exchange device 10 allows the installation of an addition pair of signal exchange coils, and further allows the installation of another pair of coils for electrical power in cases where other devices requiring electrical power are installed to steering wheel 20.

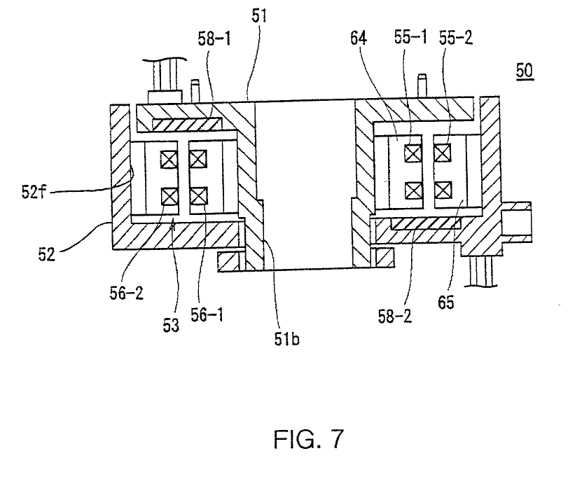

FIG. 7 describes a second embodiment of the present invention wherein electrical power transmission and signal exchange device 50 is configured much the same as the first embodiment with rotating transformer 53 located in an internal space defined by rotating part 51 and fixed part 52.

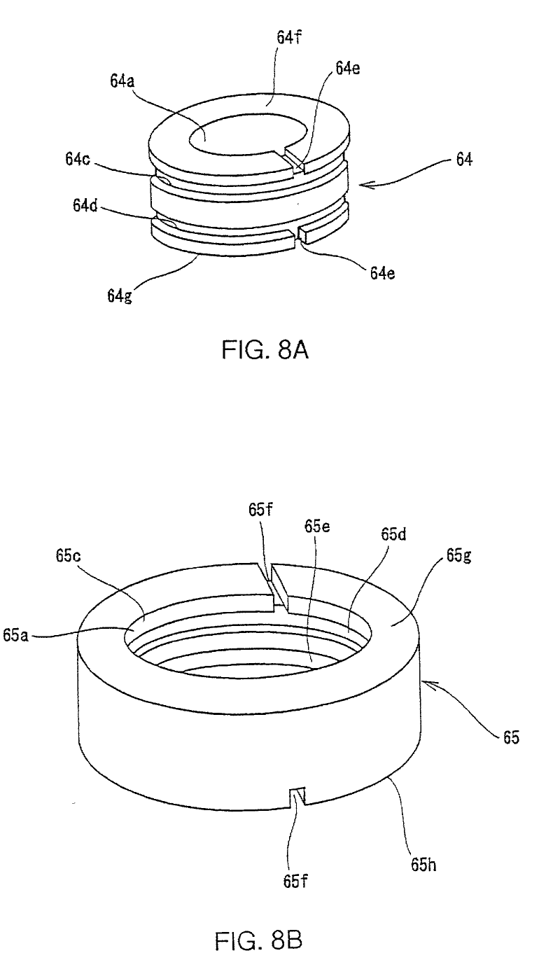

FIG. 8(A) depicts an inner magnetic core 64 located on the rotating part 51 side of rotating transformer 53, inner magnetic core 64 being a thick walled, generally cylindrical structure enclosing cylindrical space 64a that is formed to a dimension permitting connection to the external circumferential surface of cylindrical part 51b of rotating part 51. Furthermore, annular channels 64c and 64d are provided at upper and lower positions on external circumferential surface 64b, and slots 64e are formed on upper and lower end surfaces 64f and 64g to provide access to annular channels 64c and 64d.

FIG. 8(B) depicts outer magnetic core 65 located on the fixed part 52 side of rotating transformer 53, outer magnetic core 65 also being a thick walled, generally cylinder structure, but formed with an inner diameter larger than the outer diameter of inner magnetic core 64. Specifically, the inner diameter of cylindrical space 65a is slightly larger than the outer diameter of inner magnetic core 64, and the outer diameter is sized so as to connect to inner cylindrical wall of 52f of fixed part 52. Furthermore, annular channels 65d and 65e are provided at upper and lower positions on internal circumferential surface 65c of inner cylindrical space 65a, and slots 65f are formed on upper and lower surfaces 65g and 65h to connect annular channels 65d and 65e to the external space.

Coils 55-1 and 55-2 that form the electrical power coil pair are respectively installed in coil channel 64c at the upper side of inner magnetic core 64, and in coil channel 65d at the upper side of outer magnetic core 65. Coils 56-1 and 56-2 that form the signal exchange coil pair are respectively installed in coil channel 64d at the lower side of inner magnetic core 64, and in coil channel 65e at the lower side of outer magnetic core 65. This structure enables the inner coil of each pair to be maintained in concentric radial alignment with the corresponding outer coil. Moreover, multiplex processing and restoration printed circuit boards 58-1 and 58-1 are connected to signal exchange coil pair 56-2/56-2. Other elements of this second embodiment are similar to those of electrical power transmission and signal exchange device 10 of the first embodiment, and in the same way provide for an improved assembly process, a reduction in operating noise, and the ability to accommodate a larger number or circuits than a conventional flat cable.

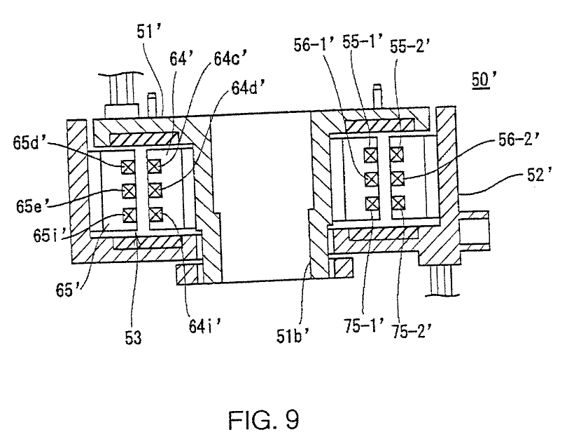

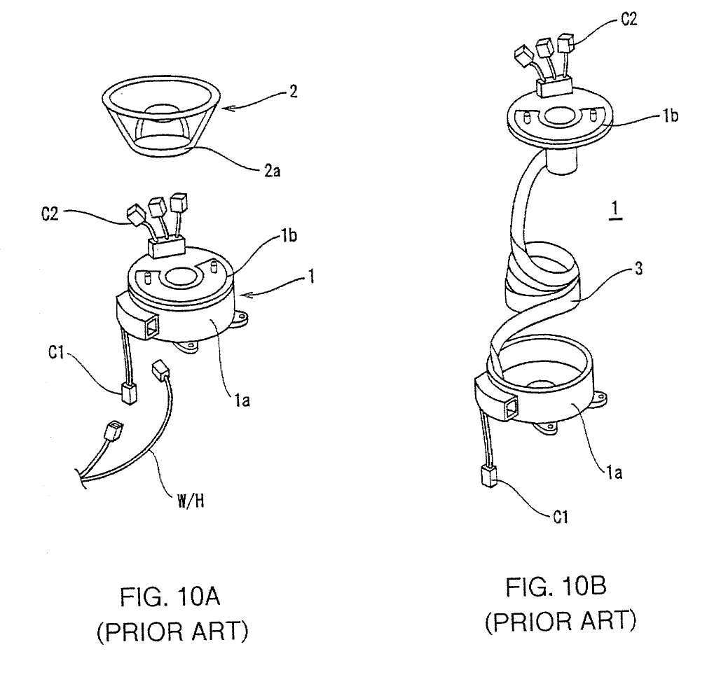

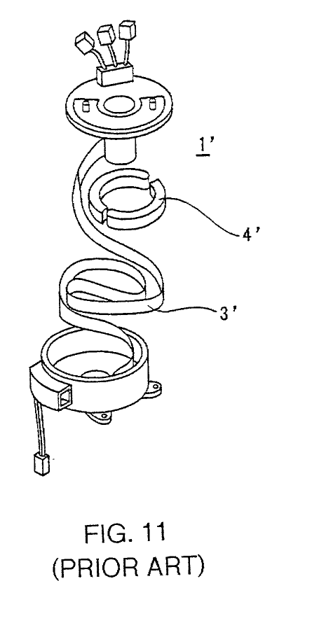

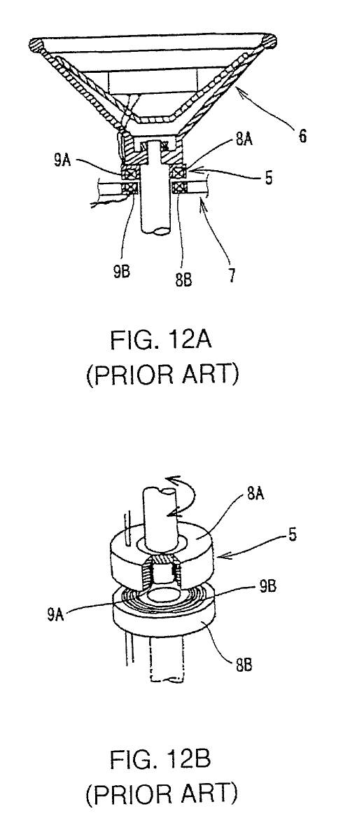

FIG. 9 depicts an electrical power transmission and signal exchange device 50′, which is a modified version of the second embodiment, in which three pairs of annular channels 64c′/65d′, 64d′/65e, and 64i′/65i′ are provided at vertically separated intervals on inner magnetic core 64′ and outer magnetic core 65′ respectively, and coil pairs 55-1′/55-2′, 56-1′/56-2′, and 75-1′/75-2′ that are respectively installed in the annular channels. Coils 75-1′ and 75-2′ have been added for signal exchange purposes in order to accommodate a greater number of circuits. In comparison to electrical power transmission and signal exchange device 50 of the first version of the second embodiment, electrical power transmission and signal exchange device 50′ is able to accommodate an increased number of circuits with only a slight increase in physical size in the height dimension and no increase in the radial dimension. In addition, as mentioned in the first embodiment, the additional coils may be applied to either electrical signal exchange or power transmission purposes.

As previously described, the present invention differs from the conventional flat cable and rotating transformer types of electrical power transmission and signal exchange devices in that it enables accommodation of a larger number of electrical circuits. Moreover, an even larger number of circuits, for use with electrical devices or for stand-by purposes, can be accommodated by the installation of additional coils. Furthermore, due to the absence of multiplexing circuitry that requires time to transfer electrical power between circuits, the present invention is able to transmit electrical power at an appropriately high rate of speed to assure timely deployment of devices like airbags that demand immediate activation.

In addition, the elimination of the flat cable mechanism provides multiple advantages that include enhanced vehicle marketability resulting from the reduction in noise generating sources, and reduced manufacturing costs resulting from the elimination of the assembly step requiring careful installation of the spirally wound flat cable.

Furthermore, as the coils in the rotating transmission can be located in either mutually opposed axial or concentric radial orientations, the invention can be selectively configured according to the specific requirements of the installation. In situations where an additional coil pair is installed in the opposing axial direction, the increase in the number of coils results in no change in the height dimension of the device, and in situations where an additional coil pair is installed as an inner and outer coil concentrically aligned on the same radial plane, the increase in the number of coils results in no dimensional enlargement of the device in the radial direction. As a result, the invention can be appropriately and selectively configured so as not to interfere with other equipment located in proximity to the steering wheel.

It is noted that the foregoing examples have been provided merely for the purpose of explanation and are in no way to be construed as limiting the present invention. While the present invention has been described with reference to an exemplary embodiment, it is understood that the words which have been used herein are words of description and illustration rather than words of limitation. Changes may be made, within the purview of the appended claims, as presently stated and amended, without departing from the scope and spirit of the present invention in its aspects. Although the present invention has been described herein with reference to particular means, materials, and embodiments, the present invention is not intended to be limited to the particulars disclosed herein; rather, the present invention extends to all functionally equivalent structures, methods, and uses, such as are within the scope of the appended claims.

The present application claims priority under 35 U.S.C. 119 of Japanese Patent Application No. 2001-064951, filed on Mar. 8, 2001, the disclosure of which is expressly incorporated by reference herein in its entirely.

The inventor claims:

1. A steering wheel electrical power transmission and signal exchange device comprising:
a rotating part fixedly attached to a steering wheel so as to rotate in unison with the steering wheel;
a fixed part fixedly attached to the vehicle body and located in relation to the rotating part so as to form an internal space; and
a rotating transformer located within said internal space to exchange electrical power transmission and signals between the vehicle body and steering wheel,
wherein said rotating transformer comprises at least two pair of mutually opposing coils, the individual coils of each coil pair being installed to said rotating part and fixed part, respectively, one coil pair being designated for electrical power transmission and one coil pair being designated for electrical signal exchange, and wherein
each coil of said coil pair designated for electrical power transmission is electrically connected to electrical current converter and electrical power circuits located on the vehicle body side and steering wheel side respectively,
and each coil of said coil pair designated for electrical signal exchange is electrically connected to a multiplex processing and restoration device located on the vehicle body side and steering wheel side, respectively.

2. The steering wheel electrical power transmission and signal exchange device according to claim 1, wherein said multiplex processing and restoration devices are installed to said rotating and fixed part, respectively, in the form of integrated circuits contained in printed circuit boards.

3. The steering wheel electrical power transmission and signal exchange device according to claim 1, wherein,
said fixed part has a generally cylindrical shape closed at the vehicle body side extremity and open at the other extremity,
said rotating part includes a generally circular cover plate positioned to cover the open extremity of said fixed part,
and one coil of a pair of coils is attached to the surface of said cover plate facing said internal space, and the other coil of said pair of coils is attached to the surface of said fixed part facing the same internal space, the disposition of said coils thus forming a pair of concentric coils mutually opposed at upper and lower positions in the axial direction.

4. The steering wheel electrical power transmission and signal exchange device according to claim 2, wherein,
said fixed part has a generally cylindrical shape closed at the vehicle body side extremity and open at the other extremity,
said rotating part includes a generally circular cover plate positioned to cover the open extremity of said fixed part,
and one coil of a pair of coils is attached to the surface of said cover plate facing said internal space, and the other coil of said pair of coils is attached to the surface of said fixed part facing the same internal space, the disposition of said coils thus forming a pair of concentric coils mutually opposed at upper and lower positions in the axial direction.

5. The steering wheel electrical power transmission and signal exchange device according to claim 1, wherein,
said fixed part has a generally cylindrical shape,
said rotating part incorporates a generally cylindrical structure that protrudes from a central region of a generally circular cover plate, said cover plate being disposed so as to close the open end of said fixed part, into the space of said fixed part,
and one coil of said coil pair is attached to the externally facing radial surface of said cylindrical structure of said rotating part, and the other coil to the internally facing radial surface of said fixed part, said coil pair being thus disposed as inner and outer concentric coils on the same radial plane.

6. The steering wheel electrical power transmission and signal exchange device according to claim 2, wherein,
said fixed part has a generally cylindrical shape,
said rotating part incorporates a generally cylindrical structure that protrudes from a central region of a generally circular cover plate, said cover plate being disposed so as to close the open end of said fixed part, into the space of said fixed part,
and one coil of said coil pair is attached to the externally facing radial surface of said cylindrical structure of said rotating part,
and the other coil to the internally facing radial surface of said fixed part, said coil pair being thus disposed as inner and outer concentric coils on the same radial plane.

7. A steering wheel electrical power transmission and signal exchange device comprising:
a rotating part fixedly attached to a steering wheel so as to rotate in unison with the steering wheel;
a fixed part fixedly attached to the vehicle body and located adjacent to the rotating part; and
an electric power transmission and electrical signal exchange device operatively connected between said rotating part and said fixed part and configured to transfer electrical power at a high rate of speed to an airbag mounted to the steering wheel and to accommodate an increased number of electrical signaling circuits between the vehicle body and the steering wheel.

8. The steering wheel electrical power transmission and signal exchange device according to claim 7, wherein said electric power transmission and electrical signal exchange device comprises a rotating transformer positioned between the rotating part and the fixed part to exchange electrical power transmission and signals between the vehicle body and steering wheel,
wherein said rotating transformer comprises at least two pair of mutually opposing coils, the individual coils of each coil pair being installed to said rotating part and fixed part, respectively, one coil pair being designated for electrical power transmission and one coil pair being designated for electrical signal exchange, and wherein
each coil of said coil pair designated for electrical power transmission is electrically connected to electrical current converter and electrical power circuits located on the vehicle body side and steering wheel side respectively,
and each coil of said coil pair designated for electrical signal exchange is electrically connected to a multiplex processing and restoration device located on the vehicle body side and steering wheel side, respectively.

9. The steering wheel electrical power transmission and signal exchange device according to claim 8, wherein said multiplex processing and restoration devices are installed to said rotating and fixed part, respectively, in the form of integrated circuits contained in printed circuit boards.

10. The steering wheel electrical power transmission and signal exchange device according to claim 8, wherein,
said fixed part has a generally cylindrical shape closed at the vehicle body side extremity and open at the other extremity,
said rotating part includes a generally circular cover plate positioned to cover the open extremity of said fixed part,
and one coil of a pair of coils is attached to the surface of said cover plate facing an internal space, and the other coil of said pair of coils is attached to the surface of said fixed part facing the same internal space, the disposition of said coils thus forming a pair of concentric coils mutually opposed at upper and lower positions in the axial direction.

11. The steering wheel electrical power transmission and signal exchange device according to claim 8, wherein,
said fixed part has a generally cylindrical shape,
said rotating part incorporates a generally cylindrical structure that protrudes from a central region of a generally circular cover plate, said cover plate being disposed so as to close an open end of said fixed part, into an internal space of said fixed part,
and one coil of said coil pair is attached to the externally facing radial surface of said cylindrical structure of said rotating part,
and the other coil to the internally facing radial surface of said fixed part, said coil pair being thus disposed as inner and outer concentric coils on the same radial plane.
